(19) United States
(12) Patent Application Publication
(10) Pub. No.: US 2024/0394652 A1
(43) Pub. Date: Nov. 28, 2024

(54) SYSTEM AND METHOD OF USING A MOBILE DEVICE TO REGISTER THE LOCATIONS OF ITEMS UPON THEIR PLACEMENT AND TO GUIDE USERS TO SUCH LOCATIONS UPON THEIR PICK-UP

(71) Applicant: Position Imaging, Inc., Portsmouth, NH (US)

(72) Inventors: Narasimhachary Nallana Chakravarty, Rollinsford, NH (US); Estuardo Carpio, Arlington, MA (US)

(21) Appl. No.: 18/673,893

(22) Filed: May 24, 2024

Related U.S. Application Data
(60) Provisional application No. 63/468,816, filed on May 25, 2023.

(51) Int. Cl. G06Q 10/0836; G06Q 10/087; G06T 17/05; G06T 19/00

(52) U.S. Cl. CPC G06Q 10/0836; G06Q 10/087; G06T 17/05; G06T 19/003; G06T 19/006

(57) ABSTRACT

A package management system comprises an area with a supporting surface used to hold packages; a computing system including at least one processor configured to process package label data associated with a package to identify the package being placed on the surface, to acquire package information from the package label associated with the package, to register a location of where the identified package is placed on the surface, and to notify a recipient of the package that the package is in the area awaiting retrieval; and a mobile device disposed within the area. The mobile device has a wireless communications transceiver and a processor configured to cause the mobile device to acquire label information by scanning the package label.

### RELATED APPLICATIONS

This application claims priority to U.S. provisional application No. 63/468,816, filed May 25, 2023 and entitled “System and Method of Using a Mobile Device to Register the Locations of Items upon their Placement and to Guide Users to such Locations upon their Pick-Up,” the entirety of which is incorporated by reference herein.

### FIELD OF THE INVENTION

The invention relates to systems, methods, and devices for package management.

### BACKGROUND

A burgeoning problem faced by many organizations involves the management and delivery of incoming packages intended for its clientele. Such management entails accepting incoming parcels, organizing them, and holding them securely until they can be delivered to their intended recipients. Often, such time- and effort-consuming tasks detract the staff from other primary responsibilities. One package management solution is a package room. A package room is a designated area within an enterprise, such as an apartment building, where couriers can drop off packages for subsequent retrieval by their intended recipients, such as apartment residents. Typically, package rooms have controlled access, to enhance security. For package rooms equipped with data entry and package tracking technologies, the drop off and pick up of packages can occur without any staff involvement. Accordingly, package rooms are becoming a fast-growing business.

For purposes of registering incoming packages, electronic kiosks with a label scanner are often externally located on a wall outside of the room. A courier bringing multiple packages into the package room registers them at the kiosk and then deposits them on a shelf or a table. Since some package rooms expect the last package scanned to be the next package placed on the shelves, after scanning a package and placing it onto a shelf the courier must return to the kiosk to individually scan the label of the next package to be placed. The process can be inefficient, especially if a courier has brought many packages to the room on a cart and must walk back and forth from the shelves to the kiosk to register all the packages.

### SUMMARY

In one aspect, a package management system comprises an area with a supporting surface used to hold packages; a computing system including at least one processor configured to process package label data associated with a package to identify the package being placed on the surface, to acquire package information from the package label associated with the package, to register a location of where the identified package is placed on the surface, and to notify a recipient of the package that the package is in the area awaiting retrieval; and a mobile device disposed within the area, the mobile device having a wireless communications transceiver and a processor configured to cause the mobile device to acquire label information by scanning the package label.

In another aspect, a method for managing packages, the method comprising the steps of: providing access to a holding area to a person in response to authenticating information submitted by the person to a kiosk; and providing a mobile device within the holding area, the mobile device having a camera, a display screen, a wireless communications transceiver, and a processor; when the person has come to place one or more packages in the holding area: capturing an image of a package label associated with a given package using the camera of the mobile device within the holding area, wirelessly transmitting the image of the package label to a computing system for image processing, acquiring package information associated with the package from the processing of the image of the package label, registering the package location in the holding area based on images captured by one or more optical sensors disposed about the holding area and on the acquired package information, and automatically sending a notification to an intended recipient of the package; when the person has come to remove one or more packages from the holding area.

In another aspect, a package management system comprises an area used to hold packages; at least one optical sensor disposed in the area to capture images within the area; a mobile device disposed within the area, the mobile device having a camera, a display screen, a wireless communications transmitter (or transceiver), and a processor configured to cause the camera to capture an image of a package label of a package being placed in the area and to cause the wireless communications transmitter to transmit the image of the package label to a computing system for image processing; and the computing system including a wireless receiver (or transceiver) that receives the image of the package label and at least one processor and/or image processor configured to process the image of the package label to acquire package information therefrom, the at least one processor being further configured to review images captured by the at least one optical sensor to determine whether the at least one optical sensor has a person and a package in its field of view as the person uses the mobile device to read the package label, to attribute the received package label data to the person seen in the field of view of the at least one optical sensor, to optically track the person as the person places a package at a location in the area, after attributing the received package label data to the person seen in the field of view of the at least one optical sensor, to detect the location in the area where the person places the package using computer-vision and/or weight-change sensing, to compare the placement location of the package with a tracked location of the person placing the package, and to register the package at the placement location in the area if the comparison of the placement location with the tracked location of the person satisfies a criterion.

In another aspect, a method for managing packages in an area, the area having at least one optical sensor therein at a known location to capture images within the area and a mobile device configured to capture images of package labels, the method comprising the steps of: receiving a package label image and/or data acquired by the mobile device; reviewing images captured by the at least one optical sensor to determine whether the at least one optical sensor has a person and package in its field of view as the person uses the mobile device to read the package label; attributing the received package label data to the person seen in the field of view of the at least one optical sensor; after attributing the received package label data to the person seen in the field of view of the at least one optical sensor, optically tracking the person as the person places a package at a location in the area; detecting the location in the area where the person places the package using computer-vision and/or weight-change sensing; comparing the placement location of the package with a tracked location of the person placing the package; and registering the package at the placement location in the area if the comparison of the placement location with the tracked location of the person satisfies a criterion.

In another aspect, a package management system comprises a holding area used to hold packages; and a mobile device disposed near or within the holding area, the mobile device having one or more cameras, an inertial measurement unit (IMU) and/or a Light-Detection and Ranging (LIDAR) system, and a processor configured to determine a location of the mobile device within the holding area in real-time using a Simultaneous Localization And Mapping (SLAM) system as the mobile device is being carried through the holding area, to cause the one or more cameras to scan a label of a package at a location within the holding area where the package has been placed, and to register the location of the package as the location of the mobile device within the holding area where the camera scanned the package label.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 shows an embodiment of an item-handling management system deployed in a holding area.

FIG. 2 shows an embodiment of a method for putting items into a package room

FIG. 3 shows an embodiment of a method for tracking a package until its placement in a room.

FIG. 4 shows an embodiment of a method for retrieving a package from the package room.

FIG. 5 shows a functional block diagram of an embodiment of a data-acquisition device.

### DETAILED DESCRIPTION

The present invention provides a solution to this inefficiency by providing a mobile data capture device within the package room. The mobile device runs application software configured to enable couriers to “read” package labels while moving about the package room to deposit them on the shelves. Thus, the courier can read labels closer to the package placement location. In addition, optical character recognition (OCR) technology automatically detects the name of the recipient, and the recipient is automatically notified of the package's arrival in the package room. Further, the courier can perform the label reading without having to lift the package to the optical scanner on the kiosk. With the handheld mobile device, the courier can read the label while the package remains on the cart (or shelf). In addition, one or more cameras in the package room capture images of the courier and the package as the mobile device held by the courier reads the label on the package. Accordingly, the cameras enable real-time video confirmation of package placement as the label information comes from the mobile device. This real-time video confirmation can facilitate registering where the package is being placed.

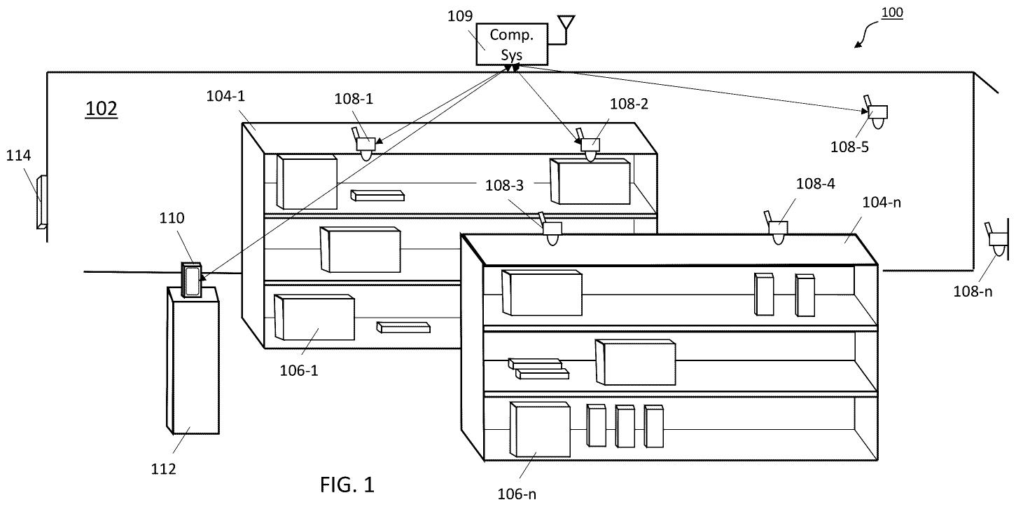

FIG. 1 shows an embodiment of an item-handling management system 100 (hereafter referred to as a package management system or system 100) deployed in a holding area 102 (hereafter, as an illustrative example, referred to as a package room 102). Example embodiments of the holding area other than a package room include, but are not limited to, the cargo bay of a delivery truck or water-going vessel, a vestibule, a corridor, a storage room, and a warehouse. For illustrative purposes, the package room 102 includes a plurality of shelves 104-a, 104-n (generally, shelf or shelves 104), and on the shelves 104 are items, objects, assets, and/or packages 106-1, 106-n (generally, package 106).

The system 100 includes an optical system having a plurality of optical sensors 108-1, 108-2, 108-3 . . . 108-n (generally, camera 108) distributed throughout the package room 102. Each camera 108 has a field of view covering a portion of the package room 102. An appropriate number of cameras 108 can be mounted at various locations inside the package room 102, including on shelves 104 and on walls, in such a way as to provide a complete field of view, or at least a functionally sufficient field of view, of the package room 102.

Before the system 100 begins to operate, each camera position is fixed to ensure the camera(s) can at least cover the package tracking area of the package room 102, specifically, the shelves 104, where packages are placed, moved, and removed. The exact position and number of cameras 108 is within the discretion of the system designer. In some cases, camera(s) can lie in an area outside the package room 102, or have a field of view from within the package room that extends outside of it. Although, this embodiment of the optical system includes six optical sensors, other embodiments can have fewer (as few as one) or more than the six. Each camera 108 may be a simple image or video capture camera in the visual range, an infrared light detection sensor, depth sensor, or other optical sensing approach. In general, this camera enables real-time package tracking when the package is within the camera's area of coverage.

In addition, each camera 108 is in communication with a computer or computer system 109 comprised of one or more processors inside the tracking area, outside of the tracking area, or a combination thereof. For example, the computer can include a DSP (digital signal processor) or a general processor of greater or lesser capability than a DSP. Communication between each camera 108 and the computer is by way of a wired or wireless path or a combination thereof. The protocol for communicating images, the compression of image data (if desired), and the image quality required are within the scope of the designer.

In one embodiment, the cameras 108 are video cameras running in parallel, and the cameras simultaneously provide images to the computer, which performs an image processing solution. For this approach, the images are merged into a pre-determined map or layout of the package room 102 and used like a panorama or merged into a mosaic. The camera images are synchronized to fit the map and operate as one camera with a panorama view.

The package management system 100 uses computer vision and/or weight sensors to know a location of and track each package 106 placed on shelves 104 in the package room 102. Examples of such package management systems are described in U.S. Pat. No. 11,436,553, titled, “System and Method of Object Tracking Using Weight Confirmation”, issued Sep. 6, 2022, in U.S. Pat. No. 11,416,805, titled, “Light-based Guidance For Package Tracking Systems”, issued Aug. 16, 2022, and in U.S. Pat. Appl. Pub. No. US-2018-0197139-A1, application Ser. No. 15/861,414, filed Jan. 3, 2018, titled, “Package Delivery-sharing System and Methods”, the entireties of which patents and patent application are incorporated by reference herein.

Within the package room 102 is a mobile label capture device 110 (hereafter data-acquisition device 110) disposed in a charging cradle on a stand 112 prominently displayed. Shipper systems typically identify and track packages 106 using barcodes. A barcode is placed on a package 106 when the shipper takes possession of the package. The barcode includes package identification information about the package, including the package dimensions, identification number, delivery address, shipping route and other data. The term barcode is to be broadly understood herein to include images or markings on a package that contain information or data (coded or otherwise) pertaining to the package. The data-acquisition device 110 is configured to acquire this information optically from the barcode on the package just before the courier places the package on the shelf 104 and to send the information wirelessly to the computer or computer system 109, as described in more detail below. In one embodiment, the data-acquisition device 110 is implemented with a Zebra EC-50 enterprise mobile computer configured with software to perform the operations described herein.

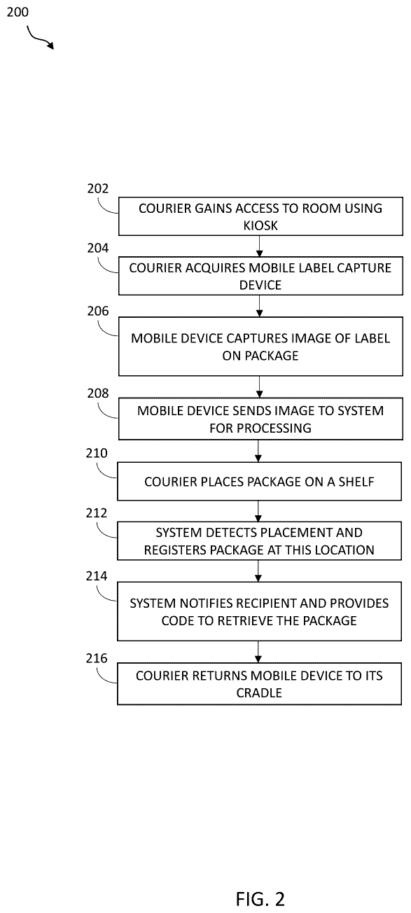

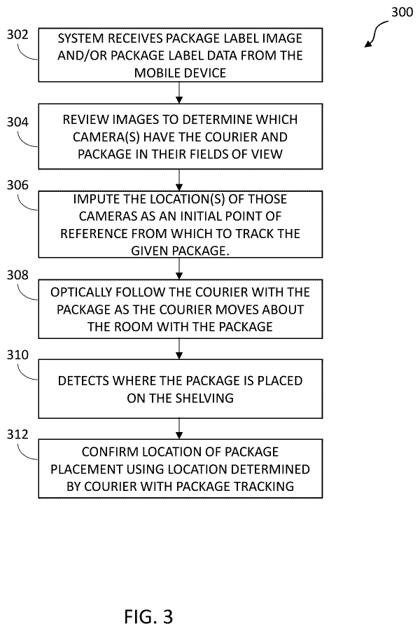

The form factor of the data-acquisition device 110 is not limiting. For example, the data-acquisition device 110 may be a conventional barcode scanner, a smartphone or tablet-like device configured with application software to perform the operations described in connection with FIG. 2 and FIG. 3. An example embodiment of the data-acquisition device 110 and techniques for wirelessly tracking the data-acquisition device 110 are described in U.S. patent application Ser. No. 14/568,468, filed Dec. 12, 2014, titled “Tracking System with Mobile Reader,” the entirety of which is incorporated by reference herein. A data acquisition device can be a mobile device that is handheld or a wearable device with any and all acquisition sensors that can be cameras, RFID readers, laser-based barcode scanners, and so on, but not limited thereto. The action of scanning can be manual that is activated by a trigger button on the data acquisition device, or the device is set to scan continuously, or non-stop, which will be automatic.

Preferably, the package room 102 is secured, with access controlled by locking all door(s) into the room and limiting entry to those persons, such as couriers and recipients, who provide authenticating information, such as biometric data, a password, a pin code, QR code, etc. For the purposes of acquiring this information, and for unlocking and locking the door in response to this information, a kiosk 114 is disposed at an entrance outside of the package room. In this example, the kiosk 114 is wall-mounted. The kiosk 114 can include a scanner that reads a label or a code affixed to a badge (for example), a biometric reader or keypad by which the person can submit information that permits access to the room, or a computer display with which the person interacts using his or her own electronic mobile device. In some embodiments, the room may be an open area with or without secured access.

FIG. 2 shows an embodiment of a method 200 for putting items (e.g., packages) into the package room. Reference is made to elements described in FIG. 1. Although the method 200 is illustrated and described as a sequence of steps, some steps may occur before, after, or concurrently with other steps. At step 202, the courier comes to a locked door and logs in using a wall-mounted kiosk to gain access to the package room. (Alternatively, the package room is an unsecured (perhaps open) holding area.) At step 204, the courier removes the mobile device from its prominently displayed location atop a stand, where it may be sitting in a charging cradle. At step 206, the courier uses the mobile device to acquire an image of a label on a package. In one embodiment, the mobile device processes this image and transmits the data related to the image wirelessly (e.g., Bluetooth®, Wi-Fi) to the package management system 100. Such data includes the information of the recipient and the tracking number extracted from the label by performing barcode scanning and optical character recognition at the mobile device. In another embodiment, the mobile device sends the image to the system. At step 208, the package management system receives the image data for (or image of) the label from the mobile device. In the instance of receiving the image, the package management system processes the image to acquire package related information therefrom, including the intended recipient of the package.

Receipt of the label image or image data tells the package management system that the next package placed on a shelf 104 is the package to be associated with the label information. In addition, concurrent with or soon after the package management system receives the label image, one or more cameras 108 capture images of the courier and the package to be placed. Based on these images, the tracking of the package in the package room can thus begin even before the package is placed on a shelf. The package management system has received the label information, knows which cameras have the package and courier within their field of view at the time of the mobile device's reading the label, and knows that the next package detected (visually and/or by weight) on the shelving belongs to that label information. The locations of these one or more cameras can play a confirmation role when establishing and registering the location of the package in the package room.

At step 210, the courier places the package on the shelf. At step 212, the package management system detects the most recently placed package on the shelf, notes the location of placement, and registers the package at this location by associating the package information acquired from the label with this package and location. The package management system can use the known locations of the cameras that captured the moment of the reading of the package label and followed the movement of the courier as the courier placed the package on the shelving, to validate or repudiate the registered location. For example, if the registered location of the package is near where the label reading occurred (or where the courier carried the package) as witnessed by the cameras, the location is validated, but if the registered location is not near the fields of view of those cameras, then the registered location can be invalidated.

At step 214, the package management system notifies the intended recipient of the package of the package's arrival and provides a PIN code or QR code (or other authenticating information) to the recipient. (Alternatively, the mobile device can send this notification to the intended recipient through an uplink to “the cloud” which refers to servers, software, and databases that are accessed over the Internet.) Steps 206 through 214 repeat for as many packages as the courier places on the shelves. The courier may move about the package room while placing packages, depositing them wherever it is suitable. The package management system tracks the courier movement as the courier places each package, and the images captured by the camera(s) can be used to help register the package location as previously described. At step 216, after finishing with all packages, the courier returns the mobile device to its cradle and leaves the room. Should the courier mistakenly take the mobile device from the package room, an alarm may sound on the mobile device (or elsewhere). A variety of techniques may be used to detect an unreturned mobile device.

FIG. 3 shows a method 300 for tracking a package until its placement in the room. At step 302, the package management system receives the package label image from the mobile device. Receipt of this package label image prompts or triggers a search of the room by the package management system for the courier with the package. At least one, probably more, of the cameras in the room have captured images of the courier as the courier reads the package label with the mobile device. The processor of the package management system reviews (step 304) these images to determine which camera or cameras have the courier and the package in their fields of view. Because the locations of each camera are known to the processor, the processor imputes (step 306) the location(s) of those cameras as an initial point of reference from which to track the given package. Typically, the courier reads the package label near where the courier intends to place the package, and subsequent images captured by the camera(s) can provide continuous confirmation of the presence of the courier at that initial point of reference. Even if the courier moves about the room to place the package, the processor, by image processing images subsequently captured by those and other cameras, can follow (step 308) the courier with the package as the courier moves about. Then, after the system detects (step 310) placement of the package on the shelving, whether by computer-vision techniques, weight-change sensing, or a combination thereof, the system can use the location derived from the images captured while following the courier's movement through the room to confirm (step 312) the location where the package placement was detected. After the system detects placement of the package on the shelving at step 310, the system provisionally registers the package at that location pending validation at step 312.

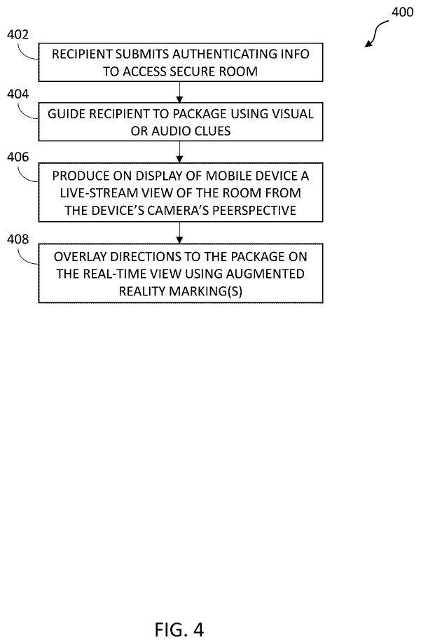

FIG. 4 shows a method 400 for retrieving a package 106 from the package room 102. In the description of the method 400, reference is made to elements of FIG. 1. At step 402, the recipient comes to the room to retrieve the package, and submits authenticating information to the wall-mounted kiosk 114, for example, a PIN or the QR code that was sent to the recipient when the package was initially registered. From the submitted information, the system 100 determines which package the recipient has come to retrieve and its current location on the shelves 104. While awaiting package pickup, the system 100 has kept track of the package's location, including following any movement of the package from its initial placement. At step 404, the system 100 uses visual or audio cues to guide the recipient to the package on the shelves.

In one embodiment, the recipient is guided to the data-acquisition device 110 sitting in the cradle atop the stand. When the system 100 identifies the package to be retrieved, the system 100 activates an application running on the device 110 that produces (step 406) on its display screen a live-stream view of the package room from the perspective of the device's camera and overlays (step 408) directions to the package on this real-time 3D view using augmented reality images or markings. Alternatively, the recipient installs this application on his or her own mobile device and after gaining access or entering to the package room, can run the application to find the target package.

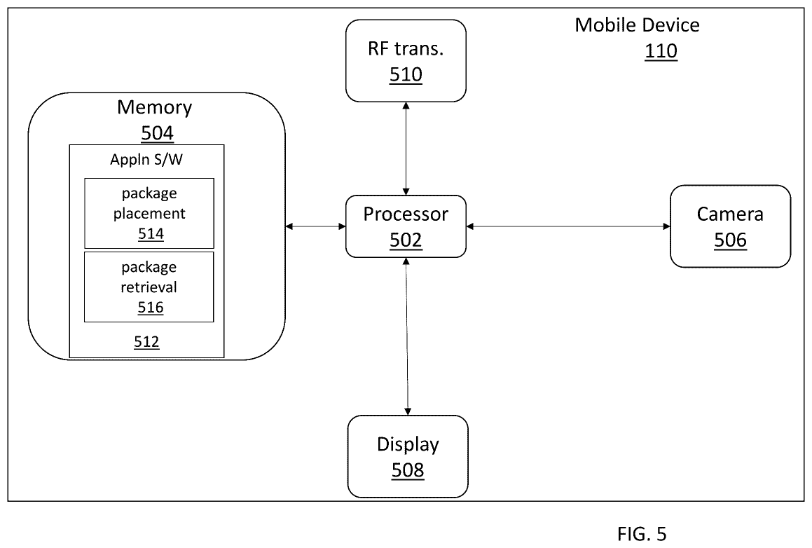

FIG. 5. shows a functional block diagram of an embodiment of the data-acquisition device 110 of FIG. 1, including a processor 502 in communication with memory 504, a camera 506, a display 508, and a RF transceiver 510. By executing the application software 512 stored in the memory 504, the processor 502 is configured to facilitate package placement and retrieval as described previously. Specifically, when executing program code 514, the processor 502 is configured to cause the camera 506 to capture an image of the package label on the package being placed and to cause the RF transceiver 510 to wirelessly send the image to the package management system 100 for image processing. In one embodiment, the processor is configured with optical character recognition software and transmits the package label data to the package management system (instead of or together with the image of the package label). When executing program code 516, the processor 502 is configured to cause the camera 506 to acquire a real-time 3D image stream of the package room, to display the image stream on the display screen 508, to overlay the live-stream image of the package room with augmented reality graphics or markings that show the location of the package being retrieved within the room and provide guidance to the location (e.g., by displaying an arrow pointing in the direction of the package).

In one embodiment, the data acquisition device 110 is configured to run any variant of Simultaneous Localization And Mapping (SLAM) algorithms. In general, SLAM algorithms construct or update a map of an unknown environment while tracking the location of the data-acquisition device (i.e., the device localizes itself) within the environment. In this embodiment, the environment is the holding area (aka package room) 102, which may or may not have secured access or cameras 108 for real-time object (e.g., package) tracking. For localizing itself within the holding area, the data acquisition device 110 can utilize Light-Detection and Ranging (LIDAR), which determines range by targeting an object or a surface with light and measuring the time for the reflected light to return to the receiver, and/or have an Inertial Measurement Unit (IMU), which includes sensors for measuring orientation and heading, examples of which include gyroscopes, accelerometers, and magnetometers. Visual SLAM (or VSLAM) algorithms, for example, use RGB cameras on smartphones to create a 3D representation of the environment. In a typical VSLAM system, an algorithm tracks points of interest in successive images captured by the camera of the mobile device. From these images, the positions of these points are attained by triangulation. From this triangulation information, the VSLAM system produces a 3D map of the environment and identifies the location of the camera (i.e., mobile device) within it.

By localizing itself within the holding area, the data acquisition device 110 can serve to register the location of a placed object. For example, when the data acquisition device 110 produces a 3D mapping of the holding area, at that moment the device considers itself to be at the origin (0, 0, 0) of this 3D mapping. All registered locations of objects within the holding area are relative to this origin location. Accordingly, the origin location must not change if an accurate tracking of the registered locations of placed packages is to be maintained. If at any point the data acquisition device 110 loses track of where it is in the holding area, the device must be brought back to the designated origin for recalibration. Recalibration may be a matter of returning the device 110 to the location of the origin and executing the SLAM application that produces the 3D mapping of the holding area. The pedestal 112 where the data acquisition device 110 sits between uses can serve as such a designated origin.

During the delivery process, the courier of a package obtains the data-acquisition device 110 from the pedestal 112 and walks to a shelf (or anywhere in the area, as shelves are not required) to place the package. While the data-acquisition device 110 moves through the area (in the courier's possession), the device 110 localizes itself in real time. After arriving at a desired drop-off location, the courier places the package at its site and scans the label on the package. In response to acquiring the label information, the device 110 associates the location of the package with its own location. For example, if the device's location at the moment of scanning the label is two meters from the pedestal, located at (0,0,0), along the x-axis of the 3D mapping, four meters from the pedestal along the y-axis of the 3D mapping, and one meter from the pedestal, along the z-axis the device 110 registers the package at location (2, 4, 1). Note, the directions of the x-axis, y-axis, and z-axis within the 3D mapping are arbitrary, but once defined are used consistently throughout the placement of all packages. After noting the location of the package, the device 110 sends a notification to the intended recipient (e.g., through an uplink to “the cloud”).

During a package pickup process, the person picking up a package runs an application on their personal mobile device and scans the PIN or QR code provided by the delivery notification, for example, at the kiosk 114. Within the coordinate system of the 3D mapping produced by the data-acquisition device 110, the system 100 knows the coordinates of this scanning location and the coordinates of the package identified by the scanned code. The system 100 can thus guide the person to the package's location within the holding area. The system 100 conveys this package location to the recipient's device, uses augmented reality using real-time overlays on the person's handheld device to guide the person to the package's location, or uses light guidance using other sensors in the holding area, for example, LEDs and lasers. More than one such scanning location may be available for use by the person as the starting point from which to retrieve the package, with the system 100 knowing the coordinates of each scanning location within the confines of the coordinate system of the 3D mapping and being able to guide the person from that starting point to the package. Alternatively, the person can use the data-acquisition device to find the package's location.

As mentioned previously, embodiments of the system 100 in which the mobile device determines the location of the dropped off package (i.e., using SLAM techniques) may or may not have cameras 108 (and related image processing) for tracking the package while the package is in the holding area. For embodiments without such cameras, for the mobile device to use augmented reality (AR) to guide a user to the package (upon pick up), the mobile device has a three-dimensional (3D) understanding of the holding area and knows the location of the package in that 3D space. For embodiments with such cameras, the mobile device can register the shelves and their locations, sizes and orientations in 3D space as part of calibration. Then, when the camera-based tracking system acquires the location of a package (from its own package detection or from the mobile device), that location is associated with a shelf location. Then when a user comes to pick up their package, the system 100 communicates the shelf ID and the package's location relative to the shelf geometry to the mobile device. The mobile device uses this information to obtain a 3D location of the package which the mobile device uses to display AR guidance.

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure, or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, and vertical and horizontal, and the like are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents. As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

What is claimed is:

1. A package management system comprising:
an area with a supporting surface used to hold packages;
a computing system including at least one processor configured to process package label data associated with a package to identify the package being placed on the surface, to acquire package information from the package label associated with the package, to register a location of where the identified package is placed on the surface, and to notify a recipient of the package that the package is in the area awaiting retrieval; and
a mobile device disposed within the area, the mobile device having a wireless communications transceiver and a processor configured to cause the mobile device to acquire label information by scanning the package label.

2. The package management system of claim 1, wherein the wireless communications transceiver has a radiofrequency (RF) transceiver, and where the scanning of the package label is performed either manually or automatically by the RF transceiver.

3. The package management system of claim 1, wherein the mobile device comprises:
a camera;
a display screen;
a wireless communications transceiver; and
a processor configured, when a package is being placed on a surface in a holding area, to use the camera to capture an image of a package label associated with the package, and to use the wireless communications transceiver to transmit the image or image data of the package label to a computing system for image processing, the processor of the mobile device being further configured, when the recipient comes to the holding area to retrieve the package, to guide the recipient to the location of the package.

4. The package management system of claim 3, wherein the processor of the mobile device is further configured to cause the camera to capture a real-time image stream of the holding area, to display the image stream on the display screen, to overlay the live-stream image of the package room with one or more augmented reality graphics that show the location within the area of the package being retrieved and provides guidance to the location.

5. A method for managing packages, the method comprising the steps of:
providing access to a holding area to a person in response to authenticating information submitted by the person to a kiosk; and
providing a mobile device within the holding area, the mobile device having a camera, a display screen, a wireless communications transceiver, and a processor;
when the person has come to place one or more packages in the holding area:
capturing an image of a package label associated with a given package using the camera of the mobile device within the holding area,
wirelessly transmitting the image of the package label to a computing system for image processing,
acquiring package information associated with the package from the processing of the image of the package label,
registering the package location in the holding area based on images captured by one or more optical sensors disposed about the holding area and on the acquired package information, and
automatically sending a notification to an intended recipient of the package and when the person has come to remove one or more packages from the holding area.

6. The method of claim 5 further comprising the steps of:
capturing a real-time 3D image stream of the holding area;
displaying the live-stream image on the display screen of the mobile device, and
overlaying the live-stream image of the holding area with one or more augmented reality graphics that show the location within the holding area of the package being retrieved and provides guidance to the location.

7. The method of claim 6 wherein the step of capturing a real-time 3D image stream of the holding area is performed by the one or more optical sensors disposed about the holding area.

8. The method of claim 6 wherein the step of capturing a real-time 3D image stream of the holding area is performed by the camera of the mobile device.

9. A package management system comprising:
an area used to hold packages;
at least one optical sensor disposed in the area to capture images within the area;
a mobile device disposed within the area, the mobile device having a camera, a display screen, a wireless communications transmitter (or transceiver), and a processor configured to cause the camera to capture an image of a package label of a package being placed in the area and to cause the wireless communications transmitter to transmit the image of the package label to a computing system for image processing; and
the computing system including a wireless receiver (or transceiver) that receives the image of the package label and at least one processor and/or image processor configured to process the image of the package label to acquire package information therefrom, the at least one processor being further configured to review images captured by the at least one optical sensor to determine whether the at least one optical sensor has a person and a package in its field of view as the person uses the mobile device to read the package label, to attribute the received package label data to the person seen in the field of view of the at least one optical sensor, to optically track the person as the person places a package at a location in the area, after attributing the received package label data to the person seen in the field of view of the at least one optical sensor, to detect the location in the area where the person places the package using computer-vision and/or weight-change sensing, to compare the placement location of the package with a tracked location of the person placing the package, and to register the package at the placement location in the area if the comparison of the placement location with the tracked location of the person satisfies a criterion.

10. A method for managing packages in an area, the area having at least one optical sensor therein at a known location to capture images within the area and a mobile device configured to capture images of package labels, the method comprising the steps of:
receiving a package label image and/or data acquired by the mobile device;
reviewing images captured by the at least one optical sensor to determine whether the at least one optical sensor has a person and package in its field of view as the person uses the mobile device to read the package label;
attributing the received package label data to the person seen in the field of view of the at least one optical sensor;
after attributing the received package label data to the person seen in the field of view of the at least one optical sensor, optically tracking the person as the person places a package at a location in the area;
detecting the location in the area where the person places the package using computer-vision and/or weight-change sensing;
comparing the placement location of the package with a tracked location of the person placing the package; and
registering the package at the placement location in the area if the comparison of the placement location with the tracked location of the person satisfies a criterion.

11. A package management system comprising:
a holding area used to hold packages; and
a mobile device disposed near or within the holding area, the mobile device having one or more cameras, an inertial measurement unit (IMU) and/or a Light-Detection and Ranging (LIDAR) system, and a processor configured to determine a location of the mobile device within the holding area in real-time using a Simultaneous Localization And Mapping (SLAM) system as the mobile device is being carried through the holding area, to cause the one or more cameras to scan a label of a package at a location within the holding area where the package has been placed, and to register the location of the package as the location of the mobile device within the holding area where the camera scanned the package label.

12. The package management system of claim 11, wherein the processor of the mobile device is further configured to construct a three-dimensional map of the holding area and to establish a location within the map as an origin location, and wherein the registered location of the package is relative to this origin location.

13. The package management system of claim 11, wherein the processor of the mobile device is further configured to notify a recipient of the package based on information from the scanned label in response to registering the location.

14. The package management system of claim 11, wherein the processor is further configured to guide the recipient to the location of the package when the recipient comes to the holding area to retrieve the package.

15. The package management system of claim 14, wherein the processor is further configured to cause the one or more cameras to capture a real-time image stream of the holding area, to display the image stream on a display screen, to overlay the live-stream image of the holding area with one or more augmented reality graphics that show the location within the holding area of the package being retrieved and provides guidance to the location.

16. The package management system of claim 11, further comprising:
at least one optical sensor disposed in the holding area to capture images of the holding area; and
a computing system including at least one processor configured to acquire label information associated with the package from the mobile device, to use the acquired label information to register the package at the location determined by the mobile device, and to track the package based on the images captured by the at least one optical sensor.

17. The package management system of claim 16, further comprising:
one or more sources of light disposed within the holding area; and
wherein the at least one processor of the computing system is further configured to illuminate the one of more sources of light to provide visual guidance to the registered location of the package being retrieved.

18. The package management system of claim 16, wherein the processor of the mobile device is further configured to register locations of surfaces within the holding area during calibration using the SLAM system and to send these locations to the computer system.

19. The package management system of claim 18, wherein the computer system sends a registered location of the surface where the package resides to the mobile device when the package is being retrieved to enable the mobile device to provide AR guidance to the package.
